(19) United States
(12) Patent Application Publication
(10) Pub. No.: US 2024/0143724 A1
(43) Pub. Date: May 2, 2024

(54) IN-CLIENT AUTHORIZATION

(71) Applicant: Zoom Video Communications, Inc., San Jose, CA (US)

(72) Inventors: Mark William Eklund, Knoxville, TN (US); Kaiyi Lei, Fremont, CA (US); Shishir Sharma, Ottawa (CA)

(21) Appl. No.: 17/977,664

(22) Filed: Oct. 31, 2022

(51) Int. Cl. G06F 21/44; H04N 7/15

(52) U.S. Cl. CPC G06F 21/44; H04N 7/15

(57) ABSTRACT

Techniques for authorization are disclosed. In an example, client software executed by a client device receives a first request to access an application within the client software. The client software obtains, from a user of the client device, an authorization to access one or more resources. The client software transmits the authorization to a virtual conference provider. The authorization is associated with the application. The client software launches the application within the client software. The client software receives a second request for authorization from the application. The client software transmits the second request for authorization to the virtual conference provider. The client software receives an authorization response from the virtual conference provider. The client software provides the authorization response to the application.

### FIELD

This disclosure generally relates to video conferencing. More specifically, but not by way of limitation, this disclosure relates to authorization of applications that execute within video conferencing software.

### BRIEF DESCRIPTION OF THE DRAWINGS

FIG. 1 depicts an example system for providing videoconferencing functionality to client devices.

FIG. 2 depicts an example system in which a video conference provider provides videoconferencing functionality to various client devices.

FIG. 3 depicts an example system for providing virtual conferences with applications.

FIG. 4 depicts a graphical user interface (“GUI”) view of a conference provided by the video conference provider.

FIG. 5 depicts a flowchart of an example of a method for securely authorizing an application.

FIG. 6 depicts an example of a sequence of events for securely authorizing an application.

FIG. 7 illustrates an example computing device for securely authorizing an application.

### DETAILED DESCRIPTION

Disclosed techniques relate to authorizing applications executing within video conferencing software. Video conferencing software can execute one or more applications, which can be developed by third parties. Examples of functionality that can be provided by such applications include facilitating access to files stored on third party services and analyzing a video conference stream.

In some cases, an application requests to access resources, such as a user's information, that are held by the video conferencing provider. To obtain access to the resources, the video conference provider asks the user whether the application is authorized to access their private user information. If so, the video conference provider will grant access, otherwise, it will deny access. This authorization process relies on protocols to that can coordinate between the application, video conference software, and/or provider. One example of this process is the Open Authentication (“OAuth”) protocol.

But existing solutions can be cumbersome. Typically, the authorization process triggers another application to launch, such as a web browser. The web browser allows the user to interact with the host of the user's information and provide authorization for the application. These additional steps and application launches burden the user and complicate the process and can provide opportunities for malicious actors to interfere. Disclosed techniques simplify and secure the third party authorization process.

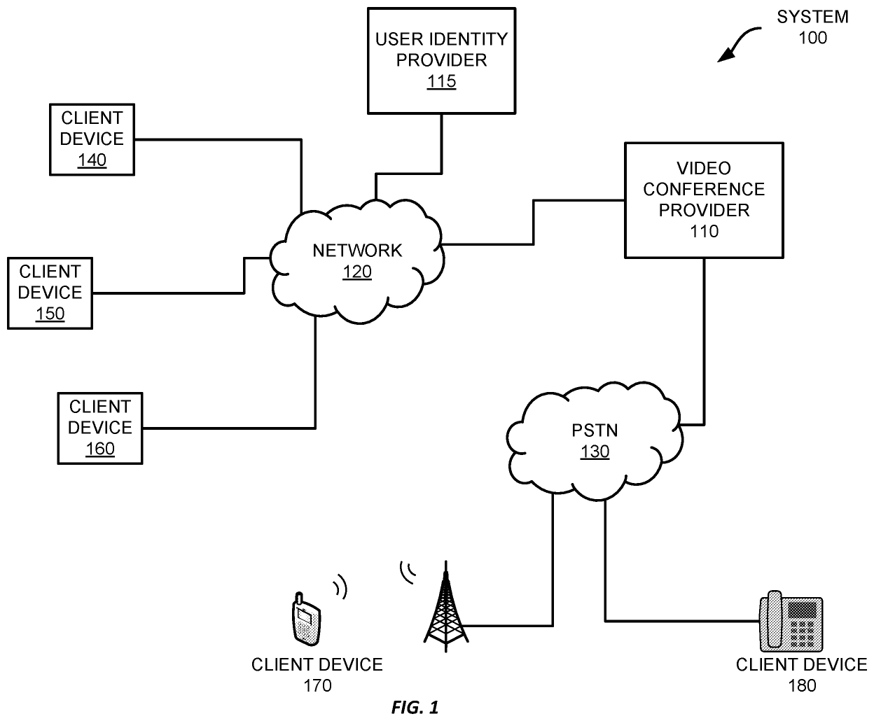

Turning now to the Figures, FIG. 1 depicts an example system 100 for providing videoconferencing functionality to client devices. In the example depicted by system 100, video conference provider 110 hosts one or more video conferences between client devices 140-180. The system 100 includes a video conference provider 110 that is connected to multiple communication networks 120, 130, through which various client devices 140-180 can participate in video conferences hosted by the video conference provider 110. For example, the video conference provider 110 can be located within a private network to provide video conferencing services to devices within the private network, or it can be connected to a public network, e.g., the internet, so it may be accessed by anyone. Other configurations include a hybrid model in which a video conference provider 110 may supply components to enable a private organization to host private internal video conferences or to connect its system to the video conference provider 110 over a public network.

System 100 optionally includes one or more user identity providers, e.g., user identity provider 115, which can provide user identity services to users of the client devices 140-160 and may authenticate user identities of one or more users to the video conference provider 110. In this example, the user identity provider 115 is operated by a different entity than the video conference provider 110, though in some examples, they may be the same entity.

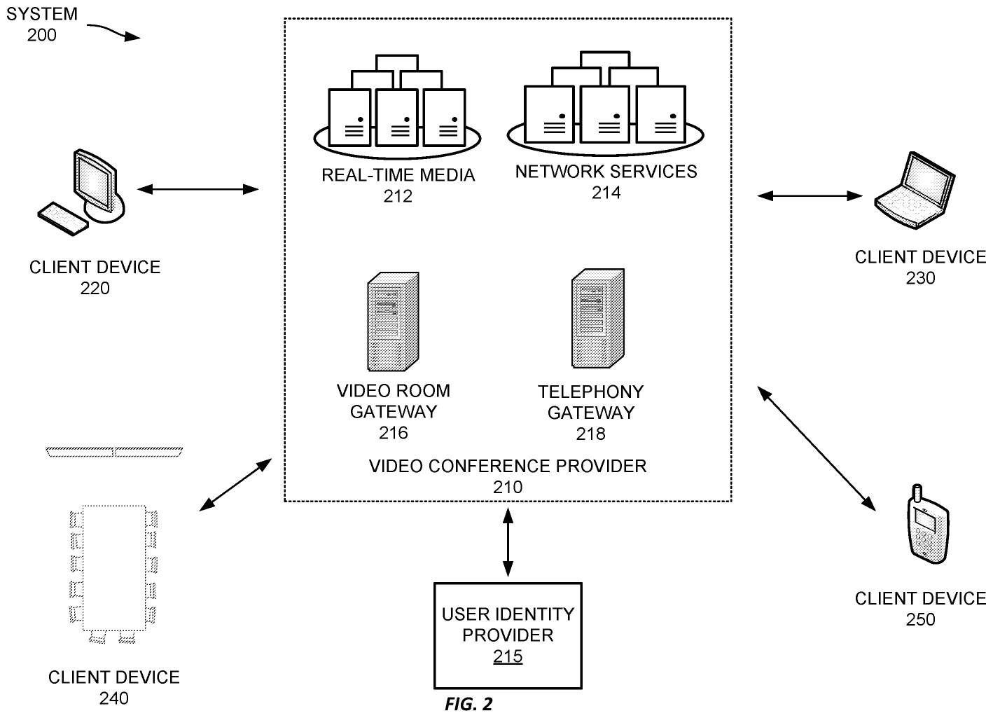

Video conference provider 110 allows clients to create videoconference meetings (or “meetings”) and invite others to participate in those meetings as well as perform other related functionality, such as recording the meetings, generating transcripts from meeting audio, generating summaries and translations from meeting audio, generating summaries and translations from meeting audio, manage user functionality in the meetings, enable text messaging during the meetings, create and manage breakout rooms from the main meeting, etc. FIG. 2, described below, provides a more detailed description of the architecture and functionality of the video conference provider 110. It should be understood that the term “meeting” encompasses the term “webinar” used herein.

Meetings facilitated by video conference provider 110 are provided in virtual rooms to which participants are connected. A room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used. Further, in some examples, and as alluded to above, a meeting may also have “a sidebar meeting.” A sidebar meeting as provided herein may be a “room” that is associated with a “main” videoconference room or “main meeting.”

To create a meeting with the video conference provider 110, a user may contact the video conference provider 110 using a client device 140-180 and select an option to create a new meeting. Such an option may be provided in a webpage accessed by a client device 140-180 or client application executed by a client device 140-180. For telephony devices, the user may be presented with an audio menu that they may navigate by pressing numeric buttons on their telephony device.

To create a meeting, the video conference provider 110 may prompt the user for certain information, such as a date, time, and duration for the meeting, a number of participants, a type of encryption to use, whether the meeting is confidential or open to the public, etc. After receiving the various meeting settings, the video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started or the host may be required to specifically admit one or more of the users.

During the meeting, the participants may employ their client devices 140-180 to capture audio or video information and stream that information to the video conference provider 110. They also receive audio or video information from the video conference provider 210, which is displayed by the respective client device 140-180 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting and they will no longer receive audio or video streams for the meeting (and will stop transmitting audio or video streams). The video conference provider 110 may also invalidate the meeting information, such as the meeting identifier or password/passcode.

To provide such functionality, one or more client devices 140-180 may communicate with the video conference provider 110 using one or more communication networks, such as communication network 120 or the public switched telephone network (“PSTN”) 130. The client devices 140-180 may be any suitable computing or communications device that have audio or video capability. For example, client devices 140-180 may be conventional computing devices, such as desktop or laptop computers having processors and computer-readable media, connected to the video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the video conference provider 110. It should be appreciated that certain computing devices may also provide telephony functionality and may operate as telephony devices. For example, smartphones typically provide cellular telephone capabilities and thus may operate as telephony devices in system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can making conventional telephone calls and is not limited solely to dedicated telephony devices like conventional telephones.

Client devices 140-160 contact the video conference provider 110 using communication network 120 and may provide information to the video conference provider 110 to access functionality provided by the video conference provider 110, such as access to create new meetings or join existing meetings. To do so, the client devices 140-160 may provide user identification information, meeting identifiers, meeting passwords or passcodes, etc. In examples that employ a user identity provider 115, a client device, e.g., client devices 140-160, may operate in conjunction with a user identity provider 115 to provide user identification information or other user information to the video conference provider 110.

A user identity provider 115 may be any entity trusted by the video conference provider 110 that can help identify a user to the video conference provider 110. For example, a trusted entity may be a server operated by a business or other organization and with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 115 by the user and secured by a password or additional security features, such as biometric authentication, two-factor authentication, etc. However, identities may be distinct from functionality such as email. For example, a health care provider may establish identities for its patients. And while such identities may have associated email accounts, the identity is distinct from those email accounts. Thus, a user's “identity” relates to a secure, verified set of information that is tied to a particular user and should be accessible only by that user. By accessing the identity, the associated user may then verify themselves to other computing devices or services, such as the video conference provider 110.

When the user accesses the video conference provider 110 using a client device, the video conference provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the video conference provider 110 either provides or denies access to its services, respectively.

For telephony devices, e.g., client devices 170-180, the user may place a telephone call to the video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the video conference provider 110. For example, telephony devices may be unable to provide user identification information to identify the telephony device or the user to the video conference provider 110. Thus, the video conference provider 110 may provide more limited functionality to such telephony devices. For example, the user may be permitted to join a meeting after providing meeting information, e.g., a meeting identifier and passcode, but they may be identified only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text messaging with other participants in the meeting.

It should be appreciated that users may choose to participate in meetings anonymously and decline to provide user identification information to the video conference provider 110, even in cases where the user has an authenticated identity and employs a client device capable of identifying the user to the video conference provider 110. The video conference provider 110 may determine whether to allow such anonymous users to use services provided by the video conference provider 110. Anonymous users, regardless of the reason for anonymity, may be restricted as discussed above with respect to users employing telephony devices, and in some cases may be prevented from accessing certain meetings or other services, or may be entirely prevented from accessing the video conference provider 110.

Referring again to video conference provider 110, in some examples, it may allow client devices 140-160 to encrypt their respective video and audio streams to help improve privacy in their meetings. Encryption may be provided between the client devices 140-160 and the video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the video conference provider 110, while allowing the video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

FIG. 2 depicts an example system 200 in which a video conference provider 210 provides videoconferencing functionality to various client devices 220-250. The client devices 220-250 include two conventional computing devices 220-230, dedicated equipment for a video conference room 240, and a telephony device 250.

Each client device 220-250 communicates with the video conference provider 210 over a communications network, such as the internet for client devices 220-240 or the PSTN for client device 250, generally as described above with respect to FIG. 1. The video conference provider 210 is also in communication with one or more user identity providers 215, which can authenticate various users to the video conference provider 210 generally as described above with respect to FIG. 1.

In this example, the video conference provider 210 employs different servers (or groups of servers) to provide video conference functionality. The video conference provider 210 uses one or more real-time media servers 212, one or more network services servers 214, one or more video room gateways 216, and one or more telephony gateway servers 218. Each of these servers 212-218 is connected to one or more communications networks to enable them to collectively provide access to and participation in one or more video conference meetings to the client devices 220-250.

Real-time media servers 212 provide multiplexed multimedia streams to meeting participants, such as client devices 220-250. While video and audio streams typically originate at the respective client devices, they are transmitted from the client devices 220-250 to the video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex the video from client device 220 and audio feeds when transmitting streams to client device 220. Instead each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the video conference provider 210 may allow a meeting participant to notify it of inappropriate behavior or content in a meeting. Such a notification may trigger the real-time media servers to 212 record a portion of the meeting for review by the video conference provider 210. Still other functionality may be implemented to take actions based on the decrypted multimedia streams at the video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the video conference provider 210 via real-time media servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference provider 210 and across many different real-time media servers 212.

Network services servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the video conference provider under a supervisory set of servers. When a client device 220-250 accesses the video conference provider 210, it will typically communicate with one or more network services servers 214 to access their account or to participate in a meeting.

When a client device 220-250 first contacts the video conference provider 210 in this example, it is routed to a network services server 214. The client device may then provide access credentials for a user, e.g., a username and password or single sign-on credentials, to gain authenticated access to the video conference provider 210. This process may involve the network services servers 214 contacting a user identity provider 215 to verify the provided credentials. Once the user's credentials have been accepted, the network services servers 214 may perform administrative functionality, like updating user account information, if the user has an identity with the video conference provider 210, or scheduling a new meeting, by interacting with the network services servers 214.

In some examples, users may access the video conference provider 210 anonymously. When communicating anonymously, a client device 220-250 may communicate with one or more network services servers 214 but only provide information to create or join a meeting, depending on what features the video conference provider allows for anonymous users. For example, an anonymous user may access the video conference provider using client device 220 and provide a meeting ID and passcode. The network services server 214 may use the meeting ID to identify an upcoming or on-going meeting and verify the passcode is correct for the meeting ID. After doing so, the network services servers 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services servers 214 may accept requests to join the meeting from various users.

To handle requests to join a meeting, the network services servers 214 may receive meeting information, such as a meeting ID and passcode, from one or more client devices 220-250. The network services servers 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services servers 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services servers 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services servers 214.

After joining a meeting, client devices will send and receive multimedia streams via the real-time media servers 212, but they may also communicate with the network services servers 214 as needed during meetings. For example, if the meeting host leaves the meeting, the network services servers 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services servers 214.

For example, if a host wishes to remove a user from a meeting, they may identify the user and issue a command through a user interface on their client device. The command may be sent to a network services server 214, which may then disconnect the identified user from the corresponding real-time media server 212.

In addition to creating and administering on-going meetings, the network services servers 214 may also be responsible for closing and tearing-down meetings once they have completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services servers 214 may deny the request.

Depending on the functionality provided by the video conference provider, the network services servers 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these video room gateway servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the video conference provider 210. For example, the video conferencing hardware may be provided by the video conference provider to one or more of its subscribers, which may provide access credentials to the video conferencing hardware to use to connect to the video conference provider 210.

The video room gateway servers 216 provide specialized authentication and communication with the dedicated video conferencing hardware that may not be available to other client devices 220-230, 250. For example, the video conferencing hardware may register with the video conference provider when it is first installed and the video room gateway may authenticate the video conferencing hardware using such registration as well as information provided to the video room gateway servers 216 when dedicated video conferencing hardware connects to it, such as device ID information, subscriber information, hardware capabilities, hardware version information etc. Upon receiving such information and authenticating the dedicated video conferencing hardware, the video room gateway servers 216 may interact with the network services servers 214 and real-time media servers 212 to allow the video conferencing hardware to create or join meetings hosted by the video conference provider 210.

The telephony gateway servers 218 enable and facilitate telephony devices' participation in meetings hosed by the video conference provider 210. Because telephony devices communicate using the PSTN and not using computer networking protocols, such as TCP/IP, the telephony gateway servers 218 act as an interface that converts between the PSTN and the networking system used by the video conference provider 210.

For example, if a user uses a telephony device to connect to a meeting, they may dial a phone number corresponding to one of the video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio signals to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server 218 is instead joined to the meeting on the telephony device's behalf.

After joining the meeting, the telephony gateway server 218 receives an audio stream from the telephony device and provides it to the corresponding real-time media server 212, and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

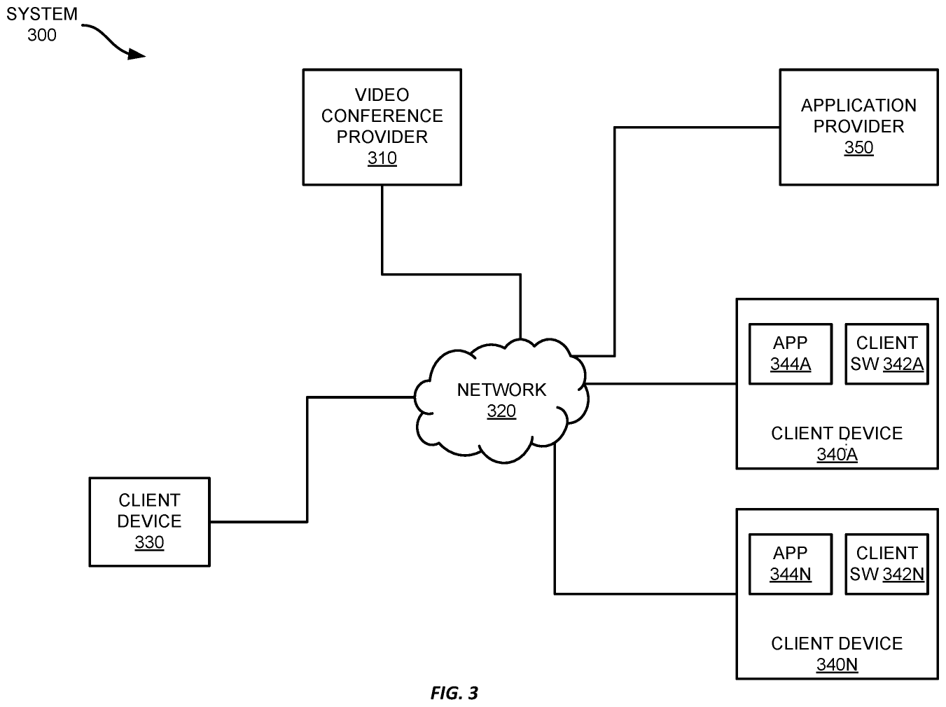

FIG. 3 depicts an example system 300 for providing virtual conferences with applications. The system 300 shown in FIG. 3 includes a video conference provider 310 and multiple client devices 330 and 340A-N that are connected to the video conference provider 310 via network 320. In this example, the network 320 is the internet; however, any communications network or combination of communications networks may be employed. While system 300 is depicted as including multiple client devices 330 and 340A-N, it should be appreciated that some example systems may not include any client devices at any particular time.

Client devices 340A-N can each operate an instance of client software 342A-N, which can be used to join and participate in video conferences hosted by the video conference provider 310. For instance, client device 340A can execute client software 342A, client device 340B can execute client software 342B, and so forth.

Client devices 340A-N can also each execute one or more applications (apps) 344A-N that are executed within the context of the client software 342A-N, rather than as standalone applications. These applications 344A-N can be provided by third party organizations or by the video conference provider 310 itself. For example, as depicted, client device 340A includes application 344A and client device 340N includes app 344N. The client software 342A-N can communicate with a virtual application provider 350 to obtain and install new applications, which the user may wish to allow to access their user information stored at the video conference provider.

To allow an application to access the user's information, the application is authorized. To authorize an application, client device 340A can install application 344A, which is provided by a third party. When the application 344A is installed, the client software 342A determines that the application will request access to the user's information stored at the video conference provider. For example, the installation package for the application 344A may identify one or more permissions it will request, which may identify accessing the user's information or account at the video conference provider 310. Upon determining that the application will request access to the user's information, the client software 342A prompts the user with a request for authorization for the application. If the user grants authorization, then the virtual conference provider stores that authorization.

Later, when the application is launched (by an action performed by the user or otherwise), the application attempts to obtain authorization to access the user's information. When the application requests authorization, the application can also generate a token, such as a state or session parameter, which is sent to the video conference provider along with a request for authorization. The video conference provider then determines whether the application has been authorized. As the application has already been authorized, the video conference provider responds with the token or a state (if one was provided) and authorization information for the application. The application verifies that the received token is the same as the token that the application provided, and if so, the application can present the authorization information to the video conference provider when it needs to access the user's information. If the token received from the video conference provider differs from the token that was sent, the application may determine that an attacker is attempting to interfere and may terminate the authorization process. However, the use of such tokens is not required.

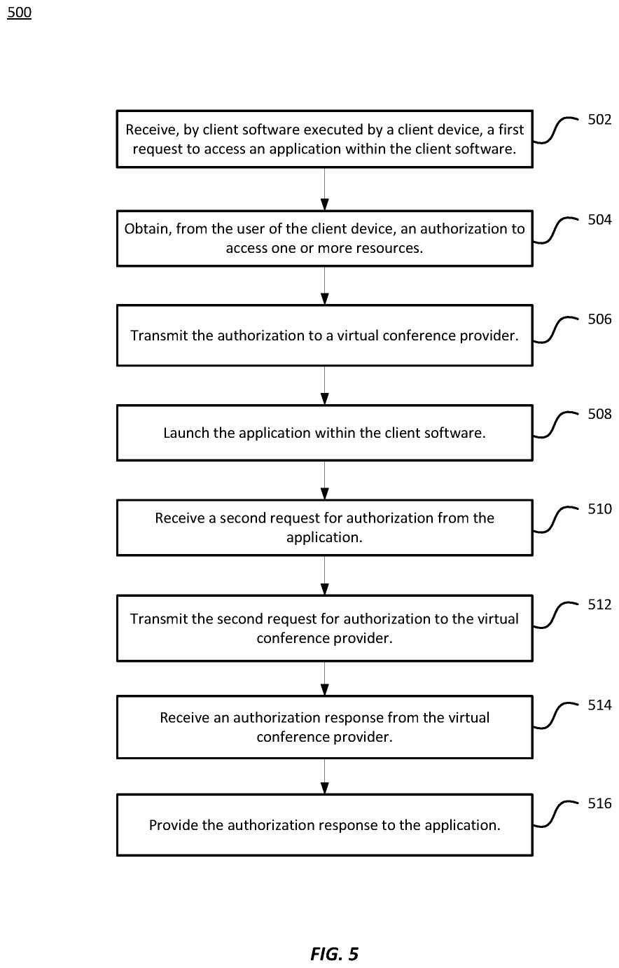

The authorization process can be performed at any stage, for example, when the application is first installed, when the application is selected by a user, when the application is first or subsequently launched, or when the application requires the information that is protected. For instance, as discussed further with respect to FIG. 5, client software executed by a client device can obtain an initial authorization on behalf of an application (e.g., a third-party application), before the third-party application is executed. Then, upon execution, the application need not obtain further authorizations from the user unless the scope of the permissions changes. Instead, the application can interact with the video conference provider, without user intervention, to obtain access to the user's information.

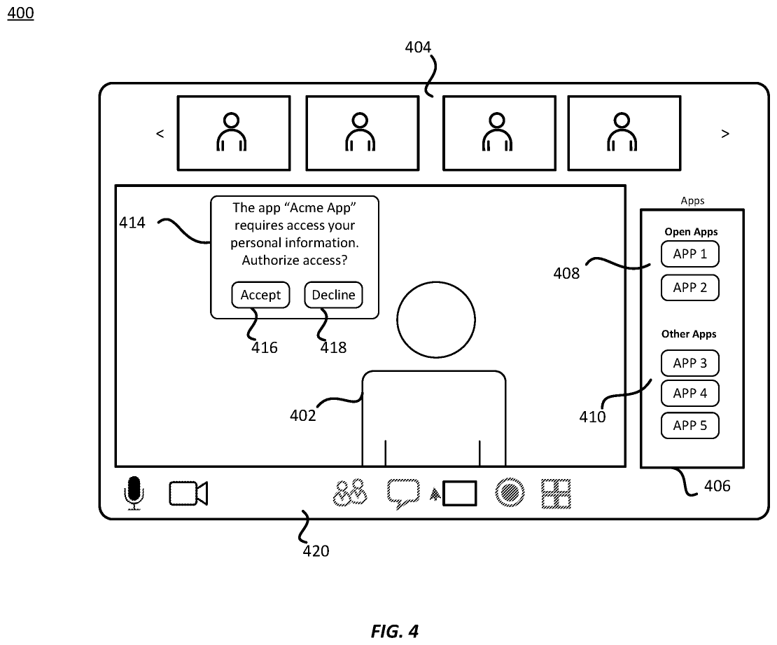

FIG. 4 depicts a graphical user interface (“GUI”) 400 view of a conference provided by the video conference provider 310. GUI view 400 depicts participant view 402, a user view 404, applications window 406, authorization prompt 414, and conference controls 420. Applications window 406 includes open apps 408, which shows the apps that the user has opened, and other apps 410, which shows other available applications.

When authorization is required, a client device can cause the GUI 400 to display authorization prompt 414, which illustrates to the user the application that the application will require access to the user's personal information. Authorization can be requested at different times, for example, before the application itself requests permission to access resources, or at the time the application needs access to the resources.

As depicted, authorization prompt 414 includes the text “The app ‘Acme App’ requires access your personal information. Authorize access?,” but other messages are possible. The user can either select the accept button 416 or the decline button 418. If the user selects the accept button 416, then the authorization process continues. If the user selects the decline button 418, then the authorization process stops and the application is denied access to the user's personal information.

FIG. 5 depicts a flowchart of an example of a method for securely authorizing an application. Method 500 can be implemented by one or more of video conference provider 310, client devices 340A-N, applications 344A-N, and/or app provider 340. While method 500 is discussed with respect to video conferencing providers, method 500 can be implemented by other systems.

It should be appreciated that method 500 provides a particular method for securely authorizing an application. Other sequences of operations may also be performed according to alternative examples. For example, alternative examples of the present invention may perform the steps outlined above in a different order. Moreover, the individual operations illustrated by method 500 may include multiple sub-operations that may be performed in various sequences as appropriate to the individual operation. Furthermore, additional operations may be added or removed depending on the particular applications. Further, the operations described in method 500 may be performed by different devices. For instance, an application may transmit directly to a video conference provider and/or via a client software. One of ordinary skill in the art would recognize many variations, modifications, and alternatives.

At block 502, method 500 involves receiving, by client software executed by a client device, a first request to access an application within the client software. Examples of accessing an application include installing (or requesting to install) the application, selecting the application for later use, selecting the application for immediate use, and launching the application. Other examples are possible. In some cases, the request to access can be delayed. For example, in a “guest mode,” the authorization request can be delayed until the resources are actually needed by the application. When the resources are needed, the application communicates with the client software 342A and the authorization moves forward.

In some cases, the client software requests the authorization from a user to permit the application to access one or more resources associated with the user. Examples of resources include information such as name, email address, birth date, and so forth. Other examples of resources can also include documents stored on a server, or copies of those documents. In some cases, the authorization request is a blanket authorization for all user information available from the video conference provider.

The application 344A can have an associated list of resources that the application 344A desires to access. In some cases, these resources are needed for an application to function. Client software 342A requests the first authorization which can include an identification of the resources to which access is desired by application 344A.

In some cases, requesting the authorization includes invoking the user interface. For example, client software 342A displays, on a user interface such as GUI 400, a prompt or a notification that includes the application name and an indication of the one or more resources. The prompt or notification can include an identification of the desired resources. An example of one such prompt is authorization prompt 414, depicted in FIG. 4. The prompt can include one or more of the particular application and an identification the resources requested by the application.

At block 504, method 500 involves obtaining, from the user of the client device, the authorization to access one or more resources. Continuing the example, the user either approves or denies the request. In some cases, the user can provide authorization for a subset of the resources the application is configured to access. In some cases, the authorization from the user is received via the user interface. For example, as depicted in FIG. 4, the user selects the accept button 416 to approve the request or the decline button 418 to deny the request.

If the user approves access by the application, the client software 342A receives the first authorization to access the resources. By contrast, if the user denies access by the application, then method 500 does not continue to block 508. Access to the resources is denied. If so, in some cases, another dialog box or prompt can be displayed in the user interface indicating that access was denied. To use application 344A, the user may select application 344A again and cause the process to restart.

At block 506, method 500 involves transmitting the authorization to a virtual conference provider. The authorization can be associated with the application. Continuing the example, the client software 342A transmits the authorization to the video conference provider 310. The first authorization in this example includes the scope of the request, though in some examples the scope is not required. The scope indicates which resources are desired.

At block 508, method 500 involves launching the application within the client software. Client software 342A causes application 344A to launch on client device 340A. Application 344A becomes visible in GUI 400. As the user has already approved the authorization, the user is not generally asked again to grant access unless the scope of access changes. In some cases, the application is not launched at block 508, but rather, method 500 continues to block 510.

At block 510, method 500 involves receiving a second request for authorization from the application. To access the resources, application 344A transmits a second request for authorization to client software 342A. The second request can include a first session identifier (or state parameter) associated with the application. Examples of session identifiers include random numbers or strings of text and/or identifiers such as an applicable Media Access Control (MAC) or IP addresses. The second request can identify the application, the version of the application, a publisher of the application, a cryptographic signature associated with the application or the publisher (which can be used to verify the authenticity of the application), an identification of the user, an identification of one or more resources the application is requesting authorization to access, or any combination of these or other parameters.

At block 512, method 500 involves transmitting the second request for authorization to the virtual conference provider. Continuing the example, client software 342A transmits the second request to video conference provider 310.

At block 514, method 500 involves receiving an authorization response from the virtual conference provider. Continuing the example, video conference provider 310 transmits the second authorization to the client software 342A. In turn, client software 342A receives the second authorization from video conference provider 310. The second authorization can include a second session identifier (or state parameter) and an authorization token that the application can later use to obtain user information from the video conference provider.

The first session identifier can be verified against the second session identifier. Application 344A ensures that the session identifiers are consistent between the request and the response to improve security. This confirms to the application 344A that sent the request that the entity that is providing authorization is the correct one, rather than a malicious actor. If the first session identifier cannot be verified against the second session identifier, then the application is denied access. In some cases, the application itself implements the denial and if executing, resets, denies access, and/or requests that the user start over.

At block 516, method 500 involves providing the authorization response to the application. Continuing the example, the client software 342A transmits a communication to application 344A that application 344A has access to the desired resources, and application 344A cannot access the desired resources. A token can be provided to application 344A for access to the resources.

In an example, access to resources can be granted to application 344A on a progressive basis. For instance, if an original authorization relates to a first set of resources, and the application 344A later requests access to a second set of resources, such a request is beyond the original permission scope and a new request indicating the second set of resources is set to the user.

An initial request beyond the scope without authorization can be denied. In other cases, the client software causes a user interface to be displayed that indicates the additional resources to which access is desired. In turn, the user can authorize access via the user interface. The user approves the access to the additional resources. Based on the approval, the client software transmits an authorization to the virtual conference provider and subsequently receives an authorization from the virtual conference provider.

Benefits of disclosed techniques also includes leveraging resource access approvals across devices. For example, a user can approve access to particular resources on a first device, and then access those resources on a second device. For example, client software 342A and/or video conference provider 310 can receive a second request for authorization from an additional instance of the application executing on an additional client device, e.g., client device 340B. Client software 342A and/or video conference provider 310 can transmit the second request for authorization to the video conference provider 310. The second request includes a first session identifier associated with the additional instance of the application executing on client device 340B. Client software 342A and/or video conference provider 310 receives a second authorization. The second authorization includes a second session identifier. Client software 342A and/or video conference provider 310 verifies the first session identifier against the second session identifier. Responsive to the verifying, client software 342A and/or video conference provider 310 grants permission to access the one or more resources to the additional instance of the application.

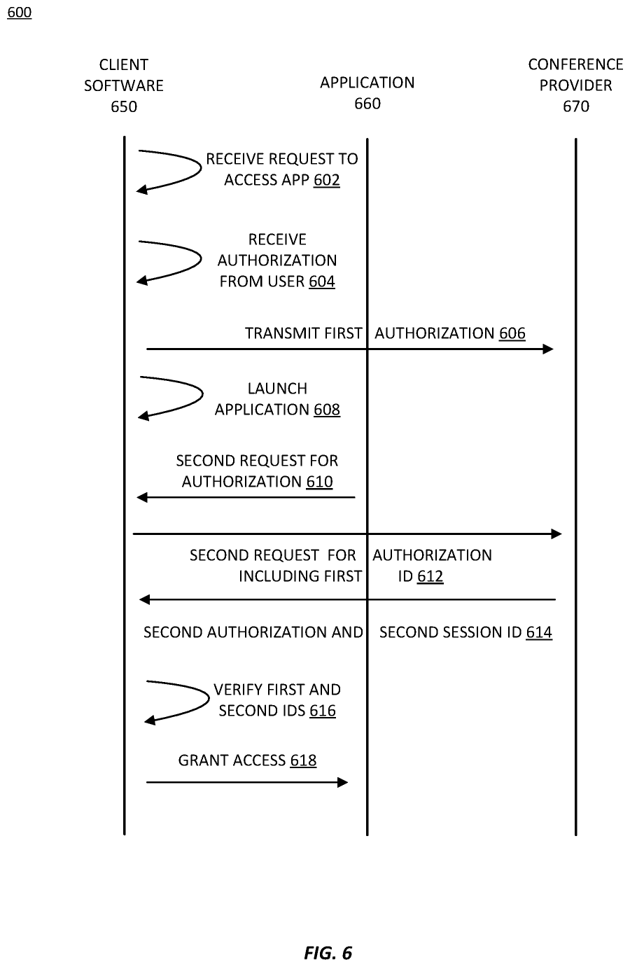

FIG. 6 depicts an example of a sequence of events 600 for securely authorizing an application. Sequence of events 600 includes events that occur between client software 650, application 660, and conference provider 670. It will be appreciated that sequence of events 600 is merely one example and other examples are possible.

At 602, a request is received at the client software 650 to access (e.g., launch) the application, generally as discussed above with respect to block 502.

At 604, the first authorization is received from the user, generally as discussed above with respect to block 504.

At 606, client software 650 transmits an authorization the conference provider 670, generally as discussed above with respect to block 506.

At 608, the client software 650 launches the application 660 within client software 650, generally as discussed above with respect to block 508.

At 610, the application 660 transmits the second request for authorization to client software 650. The second request for authorization is received at client software 650, generally as discussed above with respect to block 510.

At 612, the client software 650 transmits the request for authorization to the conference provider 670, generally as discussed above with respect to block 512. The second request for authorization can include a first identifier.

At 614, the conference provider 670 transmits the second authorization and second identifier to the client software 650, generally as discussed above with respect to block 514.

At 616, the client software 650 verifies the first and second identifiers.

At 618, the client software 650 provides the authorization response to the application, generally as discussed above with respect to block 516.

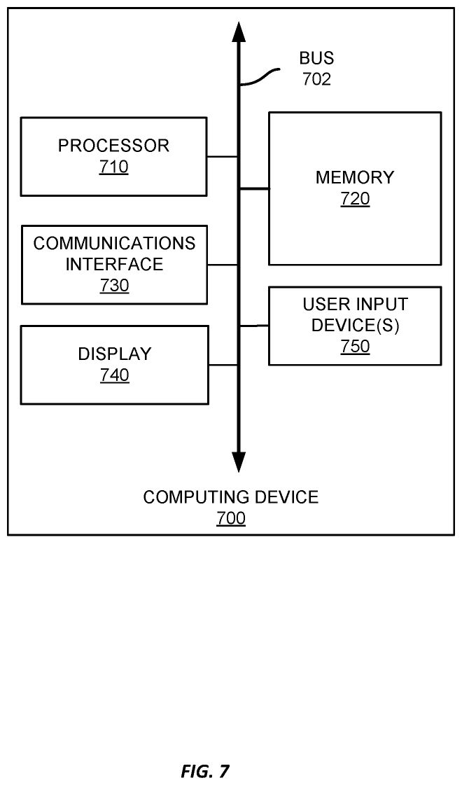

FIG. 7 illustrates an example computing device 700 for securely authorizing an application. Computing device 700 is suitable for use in example systems or methods described herein. Computing device 700 includes a processor 710 which is in communication with the memory 720 and other components of the computing device 700 using one or more communications buses 702.

The processor 710 is configured to execute processor-executable instructions stored in the memory 720 to perform one or more methods described herein, such as part or all of method 500, described above. The computing device, in this example, also includes one or more user input devices 750, such as a keyboard, mouse, touchscreen, video input device (e.g., one or more cameras), microphone, etc., to accept user input. The computing device 700 also includes a display 740 to provide visual output to a user.

The computing device 700 also includes a communications interface 730. In some examples, the communications interface 730 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

Illustration 1 is a method of securely authorizing an application, the method including: receiving, by client software executed by a client device, a first request to access an application within the client software; obtaining, from a user of the client device, an authorization to access one or more resources; transmitting the authorization to a virtual conference provider, wherein the authorization is associated with the application; launching the application within the client software; receiving a second request for authorization from the application; transmitting the second request for authorization to the virtual conference provider; receiving an authorization response from the virtual conference provider; and providing the authorization response to the application.

Illustration 2 is the method of any previous or subsequent illustration. Receiving the first request to access the application within the client software occurs without the application being launched.

Illustration 3 is the method of any previous or subsequent illustration, further including: displaying, on a user interface of the client software, an indication of the one or more resources; and receiving the authorization from the user and via the user interface.

Illustration 4 is the method of any previous or subsequent illustration, further including: transmitting a third request for authorization to the virtual conference provider, wherein the third request for authorization is for additional resources not included in the one or more resources; and receiving, from the virtual conference provider, a denial of the third request for authorization.

Illustration 5 is the method of any previous or subsequent illustration, wherein the second request includes a first session identifier associated with the application, the method further including: receiving a second authorization from the virtual conference provider, the second authorization including a second session identifier; and responsive to determining that the first session identifier does not match the second session identifier, denying permission for the application to access the one or more resources.

Illustration 6 is the method of any previous or subsequent illustration, further including: determining a need for a third request for authorization from the application based on additional resources requested by the application; displaying, on a user interface of the client software, an indication that the additional resources are requested; receiving, via the user interface and from the user of the client device, an approval for access to the additional resources; based on the approval, transmitting a third authorization to the virtual conference provider, wherein the third authorization is associated with the application; and receiving the third authorization from the virtual conference provider in response to a request by the application for the additional resources.

Illustration 7 is the method of any previous or subsequent illustration, further including: receiving, from an additional instance of the application executing on an additional client device, a second request for authorization; transmitting the second request for authorization to the virtual conference provider, wherein the second request includes a first session identifier associated with the additional instance of the application; receiving a second authorization from the virtual conference provider, the second authorization including a second session identifier; verifying the first session identifier against the second session identifier; and responsive to the verifying, granting permission to access the one or more resources to the additional instance of the application.

The above examples may be implemented on a system including a processor and/or on a non-transitory computer-readable medium. These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

That which is claimed is:

1. A method of securely authorizing an application, the method comprising:
receiving, by client software executed by a client device, a first request to access an application within the client software;
obtaining, from a user of the client device, an authorization to access one or more resources;
transmitting the authorization to a virtual conference provider, wherein the authorization is associated with the application;
launching the application within the client software;
receiving a second request for authorization from the application;
transmitting the second request for authorization to the virtual conference provider;
receiving an authorization response from the virtual conference provider; and
providing the authorization response to the application.

2. The method of claim 1, wherein receiving the first request to access the application within the client software occurs without the application being launched.

3. The method of claim 2, further comprising:
displaying, on a user interface of the client software, an indication of the one or more resources; and
receiving the authorization from the user and via the user interface.

4. The method of claim 1, further comprising:
transmitting a third request for authorization to the virtual conference provider, wherein the third request for authorization is for additional resources not included in the one or more resources; and
receiving, from the virtual conference provider, a denial of the third request for authorization.

5. The method of claim 1, wherein the second request includes a first session identifier associated with the application, the method further comprising:
receiving a second authorization from the virtual conference provider, the second authorization including a second session identifier; and
responsive to determining that the first session identifier does not match the second session identifier, denying permission for the application to access the one or more resources.

6. The method of claim 1, further comprising:
determining a need for a third request for authorization from the application based on additional resources requested by the application;
displaying, on a user interface of the client software, an indication that the additional resources are requested;
receiving, via the user interface and from the user of the client device, an approval for access to the additional resources;
based on the approval, transmitting a third authorization to the virtual conference provider, wherein the third authorization is associated with the application; and
receiving the third authorization from the virtual conference provider in response to a request by the application for the additional resources.

7. The method of claim 2, further comprising:
receiving, from an additional instance of the application executing on an additional client device, a second request for authorization;
transmitting the second request for authorization to the virtual conference provider, wherein the second request includes a first session identifier associated with the additional instance of the application;
receiving a second authorization from the virtual conference provider, the second authorization including a second session identifier;
verifying the first session identifier against the second session identifier; and
responsive to the verifying, granting permission to access the one or more resources to the additional instance of the application.

8. A system for securely authorizing an application, the system comprising:
a non-transitory computer-readable medium; and
a processor communicatively coupled to the non-transitory computer-readable medium, wherein executing the computer-executable program instructions configures the processor to perform operations comprising:
receiving, by client software executed by a client device, a first request to access an application within the client software;
obtaining, from a user of the client device, an authorization to access the one or more resources;
transmitting the authorization to a virtual conference provider, wherein the authorization is associated with the application;
launching the application within the client software;
receiving a second request for authorization from the application;
transmitting the second request for authorization to the virtual conference provider;
receiving an authorization response from the virtual conference provider; and
providing the authorization response to the application.

9. The system of claim 2, further comprising:
displaying, on a user interface of the client software, an indication of the one or more resources; and
receiving the authorization from the user and via the user interface.

10. The system of claim 8, wherein executing the computer-executable program instructions configures the processor to perform operations comprising:
transmitting a third request for authorization to the virtual conference provider, wherein the third request for authorization is for additional resources not included in the one or more resources; and
receiving, from the virtual conference provider, a denial of the third request for authorization.

11. The system of claim 8, wherein the second request includes a first session identifier associated with the application, and wherein executing the computer-executable program instructions configures the processor to perform operations comprising:
receiving a second authorization from the virtual conference provider, the second authorization including a second session identifier; and
responsive to determining that the first session identifier does not match the second session identifier, denying permission for the application to access the one or more resources.

12. The system of claim 8, wherein executing the computer-executable program instructions configures the processor to perform operations comprising:
determining a need for a third request for authorization from the application based on additional resources requested by the application;
displaying, on a user interface of the client software, an indication that the additional resources are requested;
receiving, via the user interface and from the user of the client device, an approval for access to the additional resources;
based on the approval, transmitting a third authorization to the virtual conference provider, wherein the third authorization is associated with the application; and
receiving the third authorization from the virtual conference provider in response to a request by the application for the additional resources.

13. The system of claim 8, wherein the resources comprise one or more of a name, an email address, a calendar, or one or more documents.

14. The system of claim 8, wherein executing the computer-executable program instructions configures the processor to perform operations comprising:
receiving, from an additional instance of the application executing on an additional client device, a second request for authorization;
transmitting the second request for authorization to the virtual conference provider, wherein the second request includes a first session identifier associated with the additional instance of the application;
receiving a second authorization from the virtual conference provider, the second authorization including a second session identifier;
verifying the first session identifier against the second session identifier; and
responsive to the verifying, granting permission to access the one or more resources to the additional instance of the application.

15. A non-transitory computer-readable medium comprising processor-executable instructions, wherein when executed by a processing device, the computer-executable program instructions cause the processing device to perform operations comprising:
receiving, by client software executed by a client device, a first request to access an application within the client software;
obtaining, from a user of the client device, an authorization to access the one or more resources;
transmitting the authorization to a virtual conference provider, wherein the authorization is associated with the application;
launching the application within the client software;
receiving a second request for authorization from the application;
transmitting the second request for authorization to the virtual conference provider;
receiving an authorization response from the virtual conference provider; and
providing the authorization response to the application.

16. The transitory computer-readable medium of claim 2, further comprising:
displaying, on a user interface of the client software, an indication of the one or more resources; and
receiving the authorization from the user and via the user interface.

17. The transitory computer-readable medium of claim 15, when executed by a processing device, the computer-executable program instructions cause the processing device to perform operations comprising:
transmitting a third request for authorization to the virtual conference provider, wherein the third request for authorization is for additional resources not included in the one or more resources; and
receiving, from the virtual conference provider, a denial of the third request for authorization.

18. The transitory computer-readable medium of claim 15, wherein the second request includes a first session identifier associated with the application, and wherein when executed by a processing device, the computer-executable program instructions cause the processing device to perform operations comprising:
receiving a second authorization from the virtual conference provider, the second authorization including a second session identifier; and
responsive to determining that the first session identifier does not match the second session identifier, denying permission for the application to access the one or more resources.

19. The transitory computer-readable medium of claim 15, when executed by a processing device, the computer-executable program instructions cause the processing device to perform operations comprising.
determining a need for a third request for authorization from the application based on additional resources requested by the application;
displaying, on a user interface of the client software, an indication that the additional resources are requested;
receiving, via the user interface and from the user of the client device, an approval for access to the additional resources;
based on the approval, transmitting a third authorization to the virtual conference provider, wherein the third authorization is associated with the application; and
receiving the third authorization from the virtual conference provider in response to a request by the application for the additional resources.

20. The transitory computer-readable medium of claim 15, wherein the resources comprise one or more of a name, an email address, a calendar, or one or more documents.
